(19) United States
(12) Patent Application Publication
(10) Pub. No.: US 2026/0269362 A1
(43) Pub. Date: Sep. 10, 2026

(54) THERMAL BARRIER ASSEMBLIES WITH SEALED AIR POCKETS

(71) Applicant: FORD GLOBAL TECHNOLOGIES, LLC, Dearborn, MI (US)

(72) Inventors: Jie DENG, Novi, MI (US); Mihir Devendra UPADHYE, Livonia, MI (US); Sangyeon KIM, Northville, MI (US)

(21) Appl. No.: 19/233,429

(22) Filed: Jun. 10, 2025

Related U.S. Application Data
(60) Provisional application No. 63/766,623, filed on Mar. 4, 2025.

(51) Int. Cl. H01M 10/6555; B60L 50/64; B60L 58/26; H01M 10/613; H01M 10/625; H01M 10/647; H01M 10/6551; H01M 10/6567; H01M 10/658; H01M 50/211; H01M 50/249; H01M 50/271

(52) U.S. Cl. CPC H01M 10/6555; B60L 50/64; B60L 58/26; H01M 10/613; H01M 10/625; H01M 10/647; H01M 10/6551; H01M 10/6567; H01M 10/658; H01M 50/211; H01M 50/249; H01M 50/271; H01M 2220/20

(57) ABSTRACT

Thermal barrier assembly designs are provided for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a multilayered structure that includes at least one sealed air pocket for increasing a thermal resistance across a thickness of the thermal barrier assembly. The sealed air pocket(s) may be incorporated into either a thermal fin or a thermal resistance material sheet of the thermal barrier assembly.

### CROSS-REFERENCE TO RELATED APPLICATIONS

This disclosure claims the benefit of U.S. Provisional Application No. 63/766,623, which was filed on Mar. 4, 2025 and is incorporated herein by reference in its entirety.

### TECHNICAL FIELD

This disclosure relates generally to electrified vehicle traction battery packs, and more particularly to thermal barrier assemblies having sealed air pockets for use within battery array cell stacks of traction battery packs.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a first battery cell, a second battery cell, and a thermal barrier assembly arranged between the first battery cell and the second battery cell. The thermal barrier assembly including a sealed air pocket inside the thermal barrier assembly. The sealed air pocket is configured to inhibit a transfer of thermal energy between the first battery cell and the second battery cell.

In a further non-limiting embodiment of the foregoing traction battery pack, the first battery cell, the second battery cell, and the thermal barrier assembly are housed inside a housing that includes a top cover and a bottom cover.

In a further non-limiting embodiment of either of the foregoing traction battery packs, an upper fin portion of a thermal fin of the thermal barrier assembly is fixedly secured to the top cover by an adhesive.

In a further non-limiting embodiment of any of the foregoing traction battery packs, a lower fin portion of a thermal fin of the thermal barrier assembly is fixedly secured to the bottom cover by an adhesive.

In a further non-limiting embodiment of any of the foregoing traction battery packs, the thermal barrier assembly separates a first compartment where the first battery cell resides from a second compartment where the second battery cell resides.

In a further non-limiting embodiment of any of the foregoing traction battery packs, the first compartment and the second compartment establish separate coolant flow passages for receiving an immersion coolant.

In a further non-limiting embodiment of any of the foregoing traction battery packs, the thermal barrier assembly includes a first thermal fin, a second thermal fin, a first thermal resistance material layer, and a second thermal resistance material layer.

In a further non-limiting embodiment of any of the foregoing traction battery packs, the first thermal fin is positioned adjacent to the second thermal fin, and the first thermal fin and the second thermal fin are sandwiched between the first thermal resistance material layer and the second thermal resistance material layer.

In a further non-limiting embodiment of any of the foregoing traction battery packs, the first thermal fin includes a first slot, and the second thermal fin includes a second slot. The first thermal resistance material layer covers the first slot and the second thermal resistance material layer covers the second slot to form the sealed air pocket.

In a further non-limiting embodiment of any of the foregoing traction battery packs, the first slot and the second slot are aligned with one another.

In a further non-limiting embodiment of any of the foregoing traction battery packs, the first slot and the second slot are staggered relative to one another.

In a further non-limiting embodiment of any of the foregoing traction battery packs, the thermal barrier assembly includes a thermal fin sandwiched between a first thermal resistance material layer and a second thermal resistance material layer.

In a further non-limiting embodiment of any of the foregoing traction battery packs, the thermal fin includes a slot that is covered by the first thermal resistance material layer and the second thermal resistance material layer to form the sealed air pocket.

In a further non-limiting embodiment of any of the foregoing traction battery packs, the thermal barrier assembly includes a plurality of thermal resistance material strips sandwiched between a first thermal fin and a second thermal fin.

In a further non-limiting embodiment of any of the foregoing traction battery packs, a gap extends between adjacent strips of the plurality of thermal resistance material strips, and the first thermal fin and the second thermal fin are arranged to cover opposing sides of the gap to form the sealed air pocket.

A traction battery pack according to another exemplary aspect of the present disclosure includes, among other things, a thermal barrier assembly arranged to partition a battery cell stack into a first compartment and a second compartment. The thermal barrier assembly includes a first thermal fin and a second thermal fin that are arranged between a first thermal resistance material layer and a second thermal resistance material layer.

In a further non-limiting embodiment of the foregoing traction battery pack, the first thermal fin and the second thermal fin are each aluminum fins, and the first thermal resistance material layer and the second thermal resistance material layer are each mica sheets.

In a further non-limiting embodiment of either of the foregoing traction battery packs, the first thermal fin includes a first slot, and the second thermal fin includes a second slot. The first thermal resistance material layer covers the first slot and the second thermal resistance material layer covers the second slot to form at least one sealed air pocket inside the thermal barrier assembly.

In a further non-limiting embodiment of any of the foregoing traction battery packs, the first slot and the second slot are aligned with one another.

In a further non-limiting embodiment of any of the foregoing traction battery packs, the first slot and the second slot are staggered relative to one another.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle having a traction battery pack.

FIG. 2 illustrates an exemplary battery array of a traction battery pack.

FIG. 3 illustrates select portions of a cell stack of a battery array.

FIG. 4 is a cross-sectional view through section 4-4 of FIG. 2.

FIG. 5 illustrates an exemplary thermal barrier assembly.

FIG. 6 is an exploded view of the thermal barrier assembly of FIG. 5.

FIG. 7 is a cross-sectional view through section 7-7 of FIG. 5.

FIG. 8 is a cross-sectional view through section 8-8 of FIG. 5.

FIG. 9 illustrates another exemplary thermal barrier assembly.

FIG. 10 is an exploded view of the thermal barrier assembly of FIG. 9.

FIG. 11 is a cross-sectional view through section 11-11 of FIG. 9.

FIG. 12 is a cross-sectional view through section 12-12 of FIG. 9.

FIG. 13 is a cross-sectional view through section 13-13 of FIG. 9.

FIG. 14 illustrates another exemplary thermal barrier assembly.

FIG. 15 is an exploded view of the thermal barrier assembly of FIG. 14.

FIG. 16 is a cross-sectional view through section 16-16 of FIG. 14.

FIG. 17 is a cross-sectional view through section 17-17 of FIG. 14.

FIG. 18 illustrates yet another exemplary thermal barrier assembly.

FIG. 19 is an exploded view of the thermal barrier assembly of FIG. 18.

FIG. 20 is a cross-sectional view through section 20-20 of FIG. 18.

FIG. 21 is a cross-sectional view through section 21-21 of FIG. 18.

FIG. 22 is a cross-sectional view through section 22-22 of FIG. 18.

### DETAILED DESCRIPTION

This disclosure details thermal barrier assembly designs for use within traction battery packs. An exemplary traction battery pack may include a battery array having a cell stack housed within an array housing. The cell stack may include one or more thermal barrier assemblies arranged between adjacent battery cells of the cell stack. Each thermal barrier assembly may include a multilayered structure that includes at least one sealed air pocket for increasing a thermal resistance across a thickness of the thermal barrier assembly. The sealed air pocket(s) may be incorporated into either a thermal fin or a thermal resistance material sheet of the thermal barrier assembly. These and other features are discussed in greater detail in the following paragraphs of this detailed description.

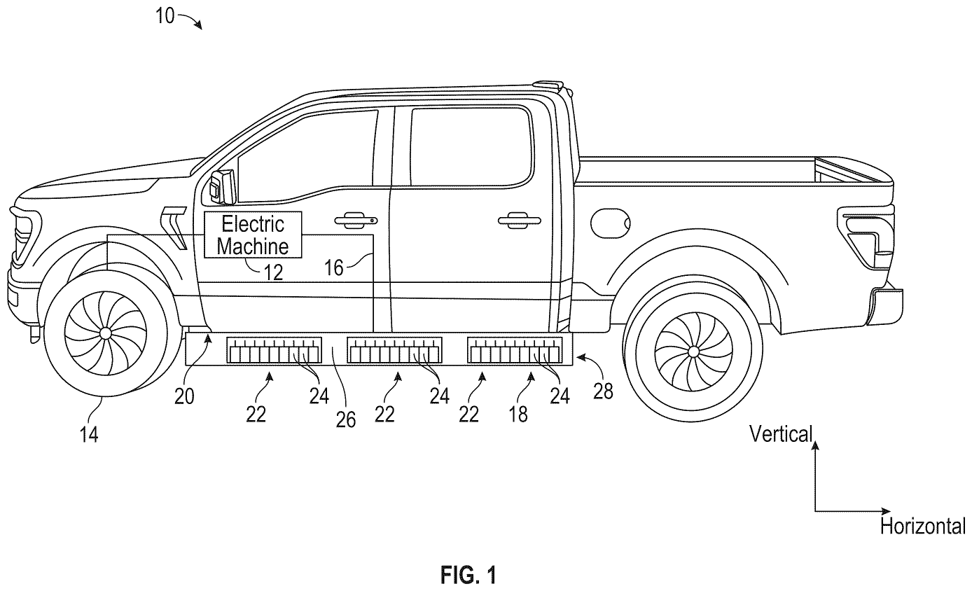

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a pickup truck. However, the electrified vehicle 10 could alternatively be a sedan, a sport utility vehicle (SUV), a van, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure.

In an embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery modules, assemblies, or groupings of rechargeable battery cells 24) capable of outputting electrical power to power the electric machine 12 and/or other electrical loads of the electrified vehicle 10. The one or more battery arrays 22 of the traction battery pack 18 may each include a plurality of battery cells 24 that store energy for powering the various electrical loads of the electrified vehicle 10. The traction battery pack 18 could employ any number of battery arrays 22 and battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, lithium manganese rich, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28 of the traction battery pack 18. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

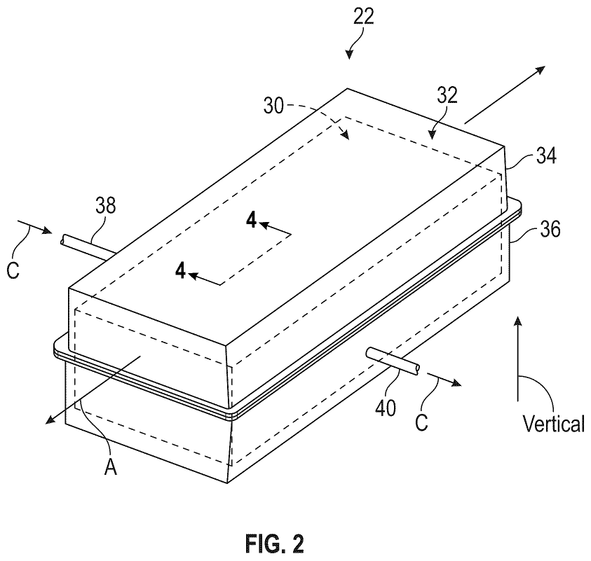

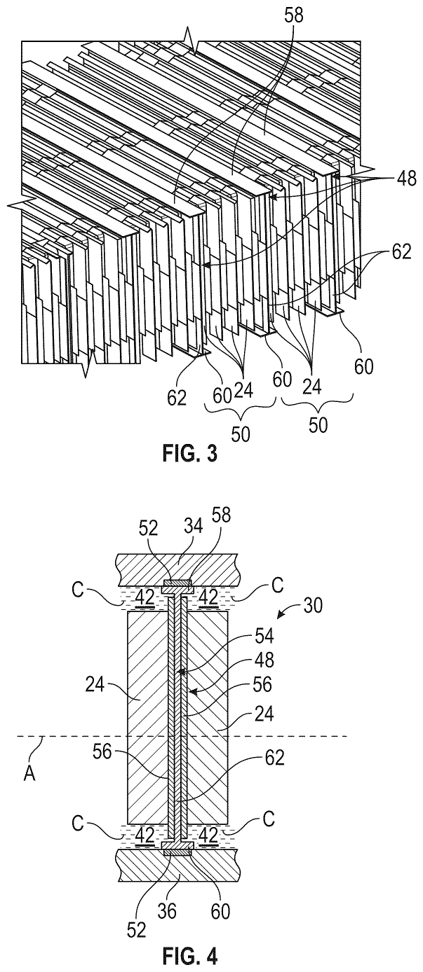

FIGS. 2-4 illustrates features associated with a battery array 22 of a traction battery pack. For example, the traction battery pack 18 of the electrified vehicle 10 of FIG. 1 could include one or more battery arrays having a design substantially similar to that of the battery array 22 shown in FIGS. 2-4.

The battery array 22 may include one or more cell stacks 30 housed inside an array housing 32. The array housing 32 may include a top cover 34 and a bottom cover 36, which may both be tray-like structures. The top cover 34 may be positioned vertically above the bottom cover 36. Various terms such as “above,” “below,” “top,” and “bottom” are used relative to the arrangement of the components of the traction battery pack 18 in the various drawings and should not otherwise be deemed limiting. These terms are referenced relative to the general orientation of the traction battery pack 18 when installed on the electrified vehicle 10 of FIG. 1. Vertical, for purposes of this disclosure, is also with reference to ground and the manner the traction battery pack 18 is oriented when installed on the electrified vehicle 10.

The top cover 34 may be secured (e.g., bolted, welded, adhered, etc.) to the bottom cover 36 to provide a sealed enclosure for housing the cell stack 30. The size, shape, and configuration of the array housing 32 could vary within the scope of this disclosure.

The cell stack 30 may include a plurality of the battery cells 24. Thermal energy levels of the battery cells 24 of the battery array 22 can increase as the electrified vehicle 10 is operated. A thermal management system can therefore be employed for managing the thermal energy levels of the battery cells 24 of the battery array 22. The thermal management system may be configured to route a coolant C through the interior of the array housing 32 of the battery array 22 in order to manage the thermal energy levels of the battery array 22 by, for example, using the coolant C to take on and carry away thermal energy from the battery cells 24 of the cell stack 30.

In an embodiment, the thermal management system is an immersion thermal management system in which portions of the cell stack 30, here at least portions of the battery cells 24, for example, can be immersed in the coolant C. Thermal energy can transfer between the coolant C and the battery cells 24 as the coolant C flows over and/or around the battery cells 24 inside the array housing 32. The coolant C can help manage thermal energy levels of the battery cells 24 as well as other components of the battery array 22.

The thermal management system can deliver the coolant C to the interior of the battery array 22 through an inlet 38 of the array housing 32. The coolant C can fill one or more open areas (see, e.g., compartments 42, which are best shown in FIG. 4) inside the battery array 22 such that the battery cells 24 are directly contacted by the coolant C. The coolant C can take on thermal energy from the battery cells 24 for managing the thermal energy levels of the battery array 22. The coolant C may exit the battery array 22 through an outlet 40 of the array housing 32. In an embodiment, both the inlet 38 and the outlet 40 are provided through the bottom cover 36 of the array housing 32. However, other inlet 38 and/or outlet 40 locations are contemplated within the scope of this disclosure.

The coolant C exiting through the outlet 40 can move to a thermal energy exchange device (not shown), such as a heat exchanger, for example, where thermal energy can be transferred from the coolant C to atmosphere. A pump (not shown) can be operated to selectively circulate the coolant C between the battery array 22 and the thermal energy exchange device and then back to the battery array 22 as part of a closed-loop system.

The coolant C circulated in the immersion thermal management system may be a dielectric fluid or another type of non-electrically conductive fluid (e.g., oil) that is designed for immersion cooling the battery cells 24. However, other non-conductive fluids may also be suitable, and the actual chemical make-up and design characteristics (e.g., dielectric constant, maximum breakdown strength, boiling point, thermal conductivity, etc.) may vary depending on the environment the battery array 22 is to be deployed, among various other factors.

The battery cells 24 of the cell stack 30 may be arranged together along a cell stack axis A. Although a single cell stack 30 having a specific number of battery cells 24 is illustrated in the figures of this disclosure, the battery array 22 could include any number of cell stacks 30, with each cell stack 30 having any number of individual battery cells 24.

A plurality of thermal barrier assemblies 48 can be interspersed along the cell stack axis A between adjacent battery cells 24 of the cell stack 30. The thermal barrier assemblies 48 may be configured to interface with the array housing 32 for compartmentalizing the battery array 22 into multiple compartments 42. Each compartment 42 may establish a dedicated coolant flow passage for directing the coolant C through the battery array 22 as part of the immersion thermal management system described above.

Each compartment 42 may house a cell packet 50, which is a subgrouping of the plurality of battery cells 24 of the cell stack 30. Each cell packet 50 may be disposed between adjacent pairs of the thermal barrier assemblies 48 of the cell stack 30. In an embodiment, each cell packet 50 includes four battery cells 24. However, other configurations are contemplated within the scope of this disclosure, and it should be evident to persons of ordinary skill in the art having the benefit of this disclosure that the cell stack 30 could include any amount and arrangement of battery cells 24, thermal barrier assemblies 48, cell packets 50, etc.

Each thermal barrier assembly 48 may include one or more thermal fins 54, which may be made of a metallic material such as aluminum, for example, that is/are flanked by additional layers 56, such as thermal resistance material layers, for example, as part of a multi-layered sandwich structure. The thermal barrier assemblies 48 may therefore include a combination of metallic materials and thermally insulating materials, such as high temperature resistance thermoplastic or thermoset composites, aerogel materials, or mica materials, for example.

Each thermal fin 54 of the thermal barrier assembly 48 may include an upper fin portion 58, a lower fin portion 60, and a mid-fin portion 62 extending between the upper fin portion 58 and the lower fin portion 60. The upper fin portion 58 and the lower fin portion 60 may each be configured as a flange that extends at a transverse angle (e.g., about perpendicular) from the mid-fin portion 62. The upper fin portion 58 may be configured to interface with the top cover 34 of the array housing 32, and the lower fin portion 60 may be configured to interface with the bottom cover 36 of the array housing 32 (see, e.g., FIG. 4). The mid-fin portion 62 of each thermal fin 54 may be positioned axially between battery cells 24 of adjacent cell packets 50 of the cell stack 30.

The upper fin portions 58 of the thermal fins 54 may extend above the battery cells 24, and the lower fin portions 60 of the thermal fins 54 may extend below the battery cells 24. The thermal fins 54 can therefore aid in establishing the compartments 42. Should, for example, a battery thermal event occur in one of the compartments 42, the thermal barrier assemblies 48 can reduce or even prevent thermal energy associated with the thermal event from moving from cell-to-cell, compartment-to-compartment, and/or cell stack-to-cell stack, thereby inhibiting the transfer of thermal energy inside the battery array 22. Moreover, due to the increased contact with the array housing 32 achieved by the upper fin portions 58 and the lower fin portions 60, the thermal barrier assemblies 48 can provide increased thermal transfer mitigation performance by directing a greater amount of heat transfer into the array housing 32.

An adhesive 52 (see FIG. 4) may be utilized to secure the upper fin portion(s) 58 to the top cover 34 of the array housing 32 and the lower fin portions(s) 60 to the bottom cover 36 of the array housing 32, thereby structurally integrating the battery array 22 in a manner that increases its rigidity/stiffness. The adhesive 52 may be a structural adhesive, such as an epoxy based adhesive or a urethane based adhesive, for example. However, other types of adhesives are contemplated within the scope of this disclosure.

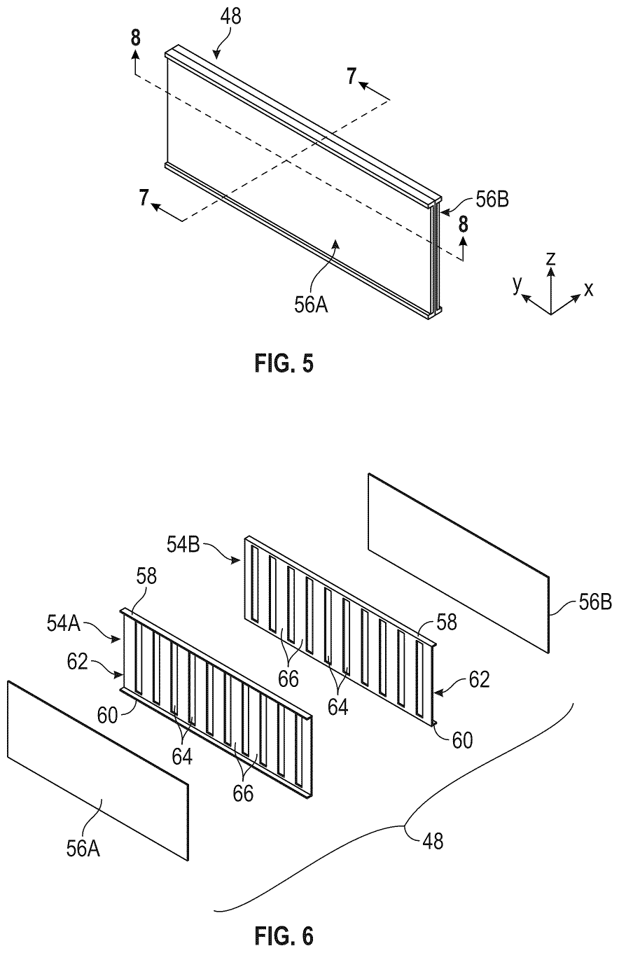

FIGS. 5-8 illustrate an exemplary thermal barrier assembly 48 that can be employed for use within the cell stack 30 of the battery array 22 discussed above for mitigating the transfer of thermal energy across a conduction path that extends in parallel to a direction of the cell stack axis A of the cell stack 30. The thermal barrier assembly 48 may include a first thermal fin 54A, a second thermal fin 54B, a first thermal resistance material layer 56A, and a second thermal resistance material layer 56B. In an embodiment, the first and second thermal fins 54A, 54B are both aluminum fins, and the first and second thermal resistance material layers 56A, 56B are both mica sheets. However, other materials or combinations of materials could be utilized to construct the thermal barrier assembly 48 within the scope of this disclosure.

The first thermal fin 54A may be positioned directly adjacent to the second thermal fin 54B within the multi-layered sandwich structure of the thermal barrier assembly 48. The first thermal fin 54A and the second thermal fin 54B may be arranged together such that the mid-fin portions 62 directly abut one another and the upper fin portions 58 and lower fin portions 60 extend in opposite directions from one another. The mid-fin portions 62 of the first and second thermal fins 54A, 54B may be sandwiched between the first thermal resistance material layer 56A and the second thermal resistance material layer 56B.

In an embodiment, the first thermal fin 54A and the second thermal fin 54B of the thermal barrier assembly 48 each include a C-shaped design. When placed side by side, the first thermal fin 54A and the second thermal fin 54B may combine to form an I-shaped barrier design. However, other cross-sectional shapes are contemplated within the scope of this disclosure.

One or more slots 64 may be formed through the mid-fin portion 62 of each of the first thermal fin 54A and the second thermal fin 54B. In an embodiment, the slots 64 are vertically (e.g., Z-axis) extending and rectangular shaped. However, the size and shape of each slot 64 is not intended to limit this disclosure. When the first and second thermal fins 54A, 54B are placed side by side to one another, the slots 64 of the first thermal fin 54A may be aligned with the slots 64 of the second thermal fin 54B in a thickness direction of the thermal barrier assembly 48 (e.g., along a direction of the cell stack axis A).

Each slot 64 may be a through-opening that is formed (e.g., stamped) through the mid-fin portion 62. Adjacent slots 64 of each thermal fin may be separated from one another by a solid section 66 of the mid-fin portion 62.

The first thermal resistance material layer 56A may be secured (e.g., adhered) to the exterior facing side of the mid-fin portion 62 of the first thermal fin 54A, and the second thermal resistance material layer 56B may be secured (e.g., adhered) to the exterior facing side of the mid-fin portion 62 of the second thermal fin 54B. The first thermal resistance material layer 56A and the second thermal resistance material layer 56B therefore cover the slots 64 of the first and second thermal fins 54A, 54B to form one or more sealed air pockets 68 inside the thermal barrier assembly 48. Air generally has a lower thermal conductivity than many solids or liquids, and therefore providing the sealed air pockets 68 increases the thermal resistance and thereby the thermal insulation capabilities of the thermal barrier assembly 48 for mitigating the transfer of thermal energy from cell packet-to-cell packet.

The size and shape of the slots 64 (and by relationship, the size and shape of the sealed air pockets 68) are not intended to limit this disclosure. In an embodiment, a surface area ratio of the slots 64 relative to non-slotted portions of the first thermal fin 54A or second thermal fin 54B can be tuned to balance the respective amounts of thermal insulation and thermal conductivity provided by the thermal barrier assembly 48. The actual surface area ratio of the slots 64 relative to the thermal fins 54A, 54B may depend on factors such as battery cell chemistry, expected thermal propagation dynamics, etc.

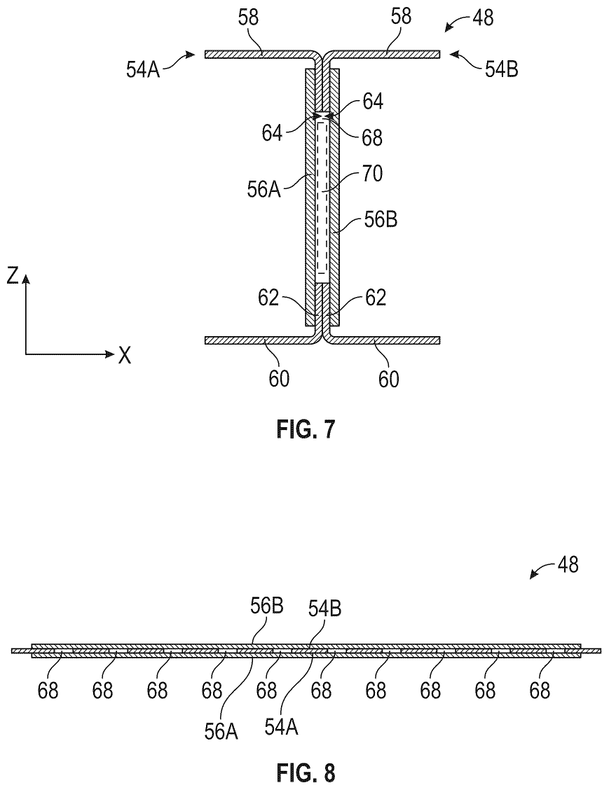

A phase change material 70 (schematically shown in FIG. 7) may optionally be positioned within one or more of the sealed air pockets 68 of the thermal barrier assembly 48. The phase change material 70 may be configured to change its phase (e.g., from a solid phase to a liquid phase) when a temperature at the thermal barrier assembly 48 exceeds a predefined temperature threshold. The latent heat resulting from the phase change can cause a relatively large amount of thermal energy to be absorbed, thereby delaying the transfer of the thermal energy across the thermal barrier assembly 48 to an adjacent cell packet 50 of the cell stack 30.

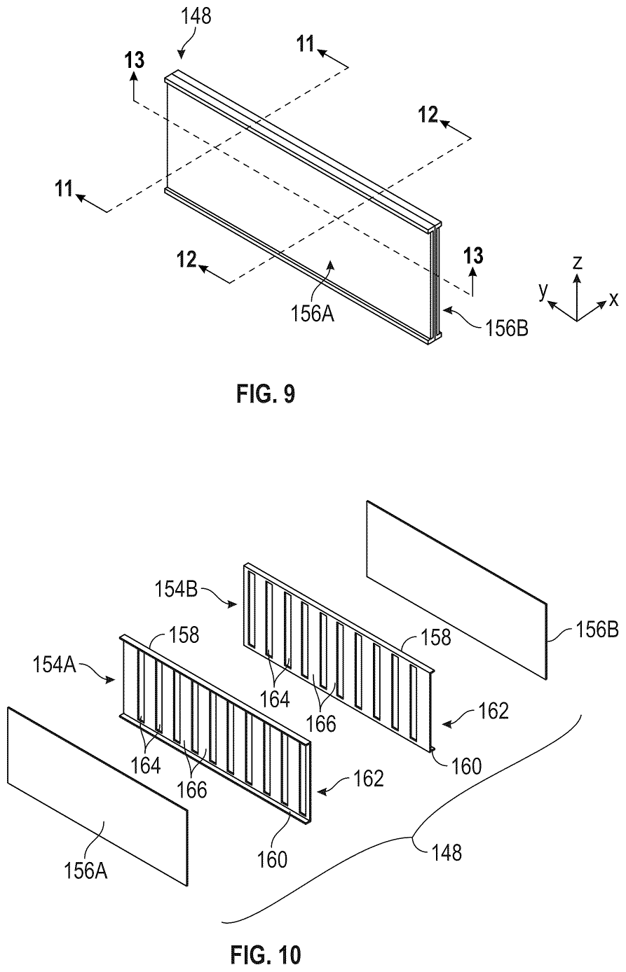

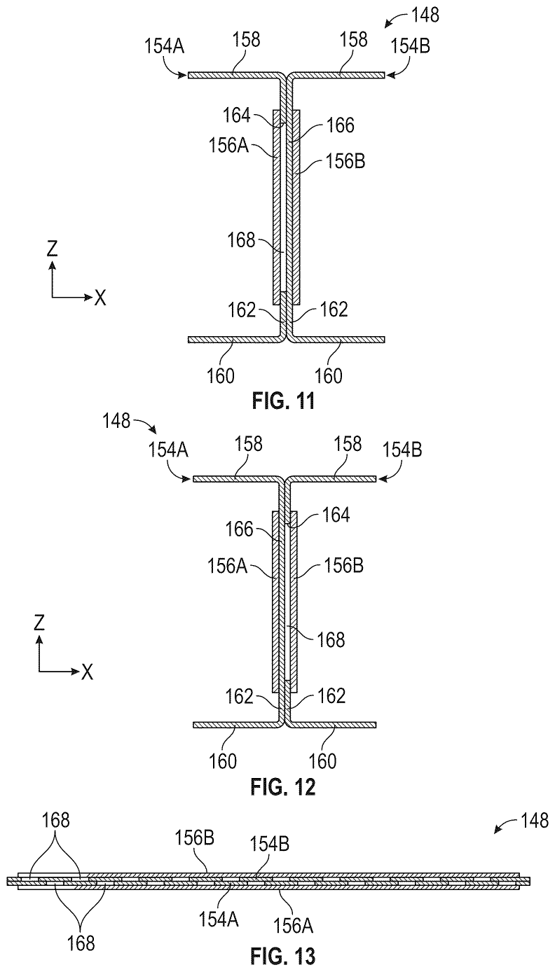

FIGS. 9-13 illustrate another exemplary thermal barrier assembly 148 that can be employed for use within the cell stack 30 of the battery array 22 discussed above for mitigating the transfer of thermal energy across a conduction path of the cell stack 30. The thermal barrier assembly 148 may include a first thermal fin 154A, a second thermal fin 154B, a first thermal resistance material layer 156A, and a second thermal resistance material layer 156B. In an embodiment, the first and second thermal fins 154A, 154B are both aluminum fins, and the first and second thermal resistance material layers 156A, 156B are both mica sheets. However, other materials or combinations of materials are contemplated within the scope of this disclosure.

The first thermal fin 154A may be positioned directly adjacent to the second thermal fin 154B within the multi-layered sandwich structure of the thermal barrier assembly 148. The first thermal fin 154A and the second thermal fin 154B may be arranged together such that the mid-fin portions 162 directly abut one another and the upper fin portions 158 and lower fin portions 160 extend in opposite directions from one another. The mid-fin portions 162 of the first and second thermal fins 154A, 154B may be sandwiched between the first thermal resistance material layer 156A and the second thermal resistance material layer 156B.

In an embodiment, the first thermal fin 154A and the second thermal fin 154B of the thermal barrier assembly 148 each include a C-shaped design. When placed side by side, the first thermal fin 154A and the second thermal fin 154B can combine to form an I-shaped design. However, other cross-sectional shapes are contemplated within the scope of this disclosure.

One or more slots 164 may be formed through the mid-fin portion 162 of each of the first thermal fin 154A and the second thermal fin 154B. In an embodiment, the slots 164 are rectangular shaped. However, the size and shape of each slot 164 is not intended to limit this disclosure.

When placed side by side to one another, the slots 164 of the first thermal fin 154A may be misaligned or staggered relative to the slots 164 of the second thermal fin 154B in a horizontal (e.g., Y-axis) direction of the thermal barrier assembly 148. The horizontal direction is transverse to the cell stack axis A.

Each slot 164 may be a vertically extending (e.g., Z-axis) through-opening that is formed (e.g., stamped) through the mid-fin portions 162. Adjacent slots 164 of each thermal fin may be separated from one another by a solid section 166 of the mid-fin portion 162.

The first thermal resistance material layer 156A may be secured (e.g., adhered) to the exterior facing side of the mid-fin portion 162 of the first thermal fin 154A, and the second thermal resistance material layer 156B may be secured (e.g., adhered) to the exterior facing side of the mid-fin portion 162 of the second thermal fin 154B. The first thermal resistance material layer 156A and the second thermal resistance material layer 156B are therefore arranged to cover the slots 164 to form one or more sealed air pockets 168 inside the thermal barrier assembly 148. Since air generally has a lower thermal conductivity than many solids or liquids, providing the sealed air pockets 168 increases the thermal resistance and thereby the thermal insulation capabilities of the thermal barrier assembly 148 for mitigating the transfer of thermal energy from cell packet-to-cell packet.

The size and shape of the slots 164 (and by relationship, the size and shape of the sealed air pockets 168) are not intended to limit this disclosure. In an embodiment, a surface area ratio of the slots 164 relative to non-slotted portions of the first thermal fin 154A or second thermal fin 154B can be tuned to balance the respective amounts of thermal insulation and thermal conductivity provided by the thermal barrier assembly 148. The actual surface area ratio of the slots 164 relative to the thermal fins 154A, 154B may depend on factors such as battery cell chemistry, expected thermal propagation dynamics, etc.

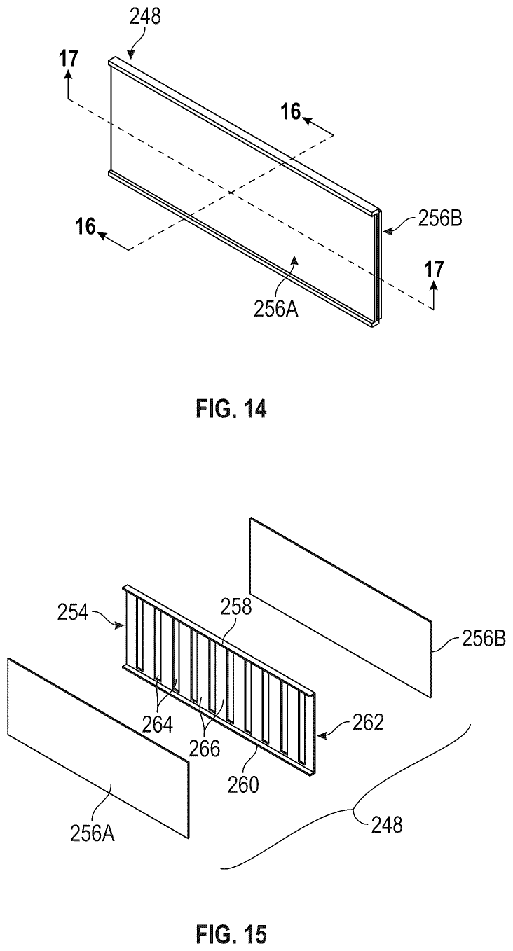

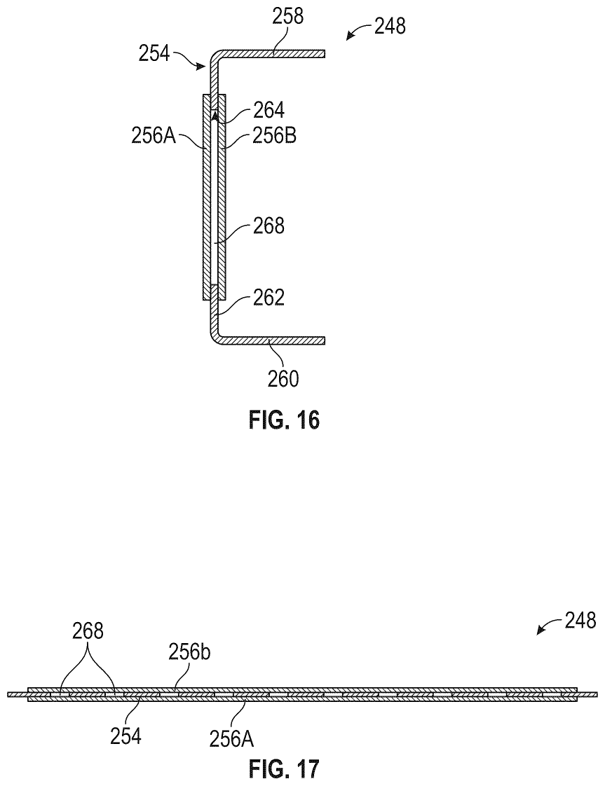

FIGS. 14-17 illustrate another exemplary thermal barrier assembly 248 that can be employed for use within the cell stack 30 of the battery array 22 discussed above for mitigating the transfer of thermal energy across a conduction path of the cell stack 30. The thermal barrier assembly 248 may include a thermal fin 254, a first thermal resistance material layer 256A, and a second thermal resistance material layer 256B. In an embodiment, the thermal fin 254 is an aluminum fin, and the first and second thermal resistance material layers 256A, 256B are both mica sheets. However, other materials or combinations of materials are contemplated within the scope of this disclosure.

A mid-fin portion 262 of the thermal fin 254 may be sandwiched between the first thermal resistance material layer 256A and the second thermal resistance material layer 256B. In an embodiment, the thermal fin 254 includes a C-shaped design. However, other cross-sectional shapes are contemplated within the scope of this disclosure.

One or more slots 264 may be formed through the mid-fin portion 262 of the thermal fin 254. In an embodiment, the slots 264 are rectangular shaped. However, the size and shape of each slot 264 is not intended to limit this disclosure.

Each slot 264 may be a vertically extending through-opening that is formed (e.g., stamped) through the mid-fin portion 262. Adjacent slots 264 of the thermal fin 254 may be separated from one another by a solid section 266 of the mid-fin portion 262.

The first thermal resistance material layer 256A may be secured (e.g., adhered) to one side of the mid-fin portion 262 of the thermal fin 254, and the second thermal resistance material layer 256B may be secured (e.g., adhered) to an opposite side of the mid-fin portion 262 of the thermal fin 254. The first thermal resistance material layer 256A and the second thermal resistance material layer 256B are therefore arranged to cover the slots 264 of the thermal fin 254 to form one or more sealed air pockets 268 inside the thermal barrier assembly 248. Air generally has a lower thermal conductivity than many solids or liquids, and therefore providing the sealed air pockets 268 increases the thermal resistance and thereby the thermal insulation capabilities of the thermal barrier assembly 248 for mitigating the transfer of thermal energy from cell packet-to-cell packet.

The size and shape of the slots 264 (and by relationship, the size and shape of the sealed air pockets 268) are not intended to limit this disclosure. In an embodiment, a surface area ratio of the slots 264 relative to non-slotted portions of the thermal fin 254 can be tuned to balance the respective amounts of thermal insulation and thermal conductivity provided by the thermal barrier assembly 248. The actual surface area ratio of the slots 264 relative to the thermal fin 254 may depend on factors such as battery cell chemistry, expected thermal propagation dynamics, etc.

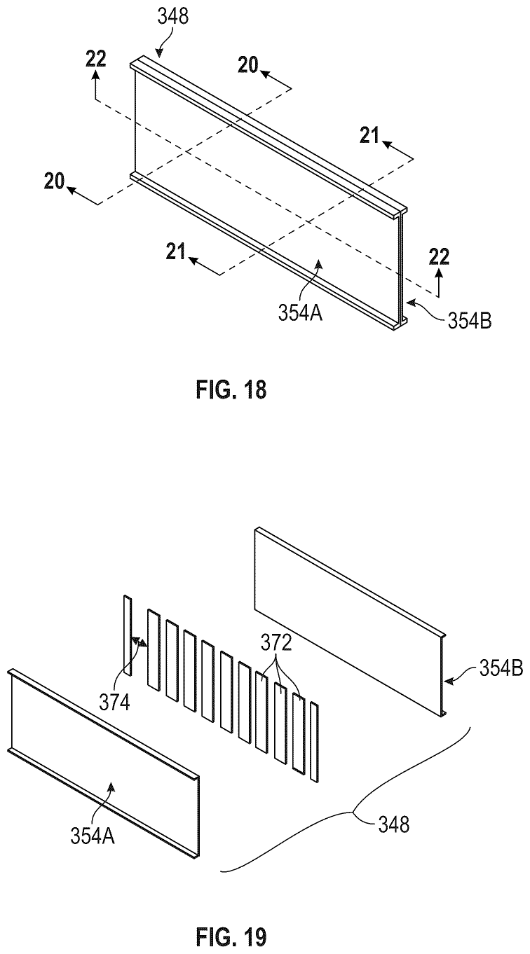

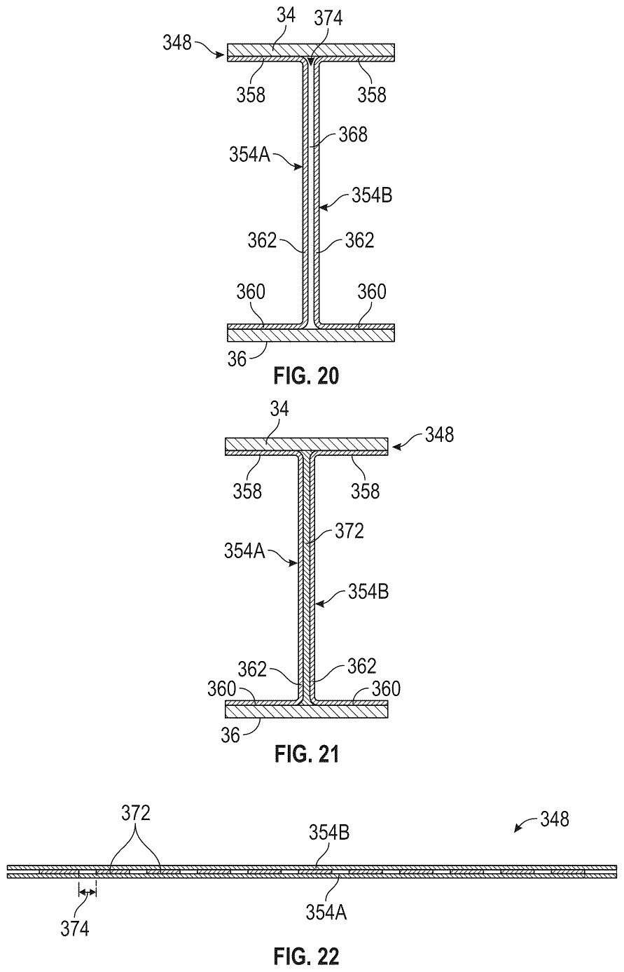

FIGS. 18-22 illustrate yet another exemplary thermal barrier assembly 348 that can be employed for use within the cell stack 30 of the battery array 22 discussed above for mitigating the transfer of thermal energy across a conduction path of the cell stack 30. The thermal barrier assembly 348 may include a first thermal fin 354A, a second thermal fin 354B, and a plurality of thermal resistance material strips 372 arranged between the first and second thermal fins 354A, 354B. In an embodiment, the first and second thermal fins 354A, 354B are both aluminum fins, and the thermal resistance material strips 372 are mica sheets. However, other materials or combinations of materials are contemplated within the scope of this disclosure.

The thermal resistance material strips 372 may be sandwiched between the first thermal fin 354A and the second thermal fin 354A of the thermal barrier assembly 348. The first thermal fin 354A and the second thermal fin 354B may be arranged adjacent to one another with the thermal resistance material strips 372 therebetween such that mid-fin portions 362 of the first and second thermal fins 354A, 354B extend in parallel with one another and upper fin portions 358 and lower fin portions 360 of the first and second thermal fins 354A, 354B extend in opposite directions from one another.

In an embodiment, the first thermal fin 354A and the second thermal fin 354B of the thermal barrier assembly 348 each include a C-shaped design. In an assembled state of the thermal barrier assembly 348, the first thermal fin 354A and the second thermal fin 354B cooperate to form an I-shaped design of the thermal barrier assembly 348. However, other cross-sectional shapes are contemplated within the scope of this disclosure.

The thermal resistance material strips 372 may be arranged within the axial space that extends between the mid-fin portions 362 of the first and second thermal fins 354A, 354B. A gap 374 may extend between adjacent strips of the plurality of thermal resistance material strips 372. Each gap 374 may be an open space that extends between adjacently positioned thermal resistance material strips 372.

When the thermal barrier assembly 348 is assembled together and the upper fin portions 358 are secured to the top cover 34 and the lower fin portions 360 are secured to the bottom cover 36, the gaps 374 are essentially covered to form sealed air pockets 368 inside the thermal barrier assembly 348. Air generally has a lower thermal conductivity than many solids or liquids, and therefore providing the sealed air pockets 368 increases the thermal resistance and thereby the thermal insulation capabilities of the thermal barrier assembly 248 for mitigating the transfer of thermal energy from cell packet-to-cell packet.

The size and shape of the gaps 374 (and by relationship, the size and shape of the sealed air pockets 368) are not intended to limit this disclosure. In an embodiment, a surface area ratio of the gaps 374 relative to that of the thermal resistance materials strips 372 can be tuned to balance the respective amounts of thermal insulation and thermal conductivity provided by the thermal barrier assembly 348.

The exemplary thermal barrier assemblies of this disclosure include sealed air pockets that increase the thermal resistance of the thermal barrier assembly. The sealed air pockets can be provided via slots formed in thermal fins of the barrier assembly or via gaps extending between adjacent strips of a thermally resistant material of the barrier assembly. By virtue of being sealed inside the assembly, the sealed air pockets are unlikely to be affected by the environment and therefore can maintain the thermal insulation capabilities of the barrier assembly both during normal battery operating conditions and battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery pack, comprising:
a first battery cell;
a second battery cell;
a thermal barrier assembly arranged between the first battery cell and the second battery cell; and
the thermal barrier assembly including a sealed air pocket inside the thermal barrier assembly, the sealed air pocket configured to inhibit a transfer of thermal energy between the first battery cell and the second battery cell.

2. The battery pack as recited in claim 1, wherein the first battery cell, the second battery cell, and the thermal barrier assembly are housed inside a housing that includes a top cover and a bottom cover.

3. The battery pack as recited in claim 2, wherein an upper fin portion of a thermal fin of the thermal barrier assembly is fixedly secured to the top cover by an adhesive.

4. The battery pack as recited in claim 2, wherein a lower fin portion of a thermal fin of the thermal barrier assembly is fixedly secured to the bottom cover by an adhesive.

5. The battery pack as recited in claim 1, wherein the thermal barrier assembly separates a first compartment where the first battery cell resides from a second compartment where the second battery cell resides.

6. The battery pack as recited in claim 5, wherein the first compartment and the second compartment establish separate coolant flow passages for receiving an immersion coolant.

7. The battery pack as recited in claim 1, wherein the thermal barrier assembly includes a first thermal fin, a second thermal fin, a first thermal resistance material layer, and a second thermal resistance material layer.

8. The battery pack as recited in claim 7, wherein the first thermal fin is positioned adjacent to the second thermal fin, and the first thermal fin and the second thermal fin are sandwiched between the first thermal resistance material layer and the second thermal resistance material layer.

9. The battery pack as recited in claim 8, wherein the first thermal fin includes a first slot and the second thermal fin includes a second slot, and further wherein the first thermal resistance material layer covers the first slot and the second thermal resistance material layer covers the second slot to form the sealed air pocket.

10. The battery pack as recited in claim 9, wherein the first slot and the second slot are aligned with one another.

11. The battery pack as recited in claim 9, wherein the first slot and the second slot are staggered relative to one another.

12. The battery pack as recited in claim 1, wherein the thermal barrier assembly includes a thermal fin sandwiched between a first thermal resistance material layer and a second thermal resistance material layer.

13. The battery pack as recited in claim 12, wherein the thermal fin includes a slot that is covered by the first thermal resistance material layer and the second thermal resistance material layer to form the sealed air pocket.

14. The battery pack as recited in claim 1, wherein the thermal barrier assembly includes a plurality of thermal resistance material strips sandwiched between a first thermal fin and a second thermal fin.

15. The battery pack as recited in claim 14, wherein a gap extends between adjacent strips of the plurality of thermal resistance material strips, and the first thermal fin and the second thermal fin are arranged to cover opposing sides of the gap to form the sealed air pocket.

16. A battery pack, comprising:
a thermal barrier assembly arranged to partition a battery cell stack into a first compartment and a second compartment; and
the thermal barrier assembly including a first thermal fin and a second thermal fin that are arranged between a first thermal resistance material layer and a second thermal resistance material layer.

17. The battery pack as recited in claim 16, wherein the first thermal fin and the second thermal fin are each aluminum fins, and the first thermal resistance material layer and the second thermal resistance material layer are each mica sheets.

18. The battery pack as recited in claim 16, wherein the first thermal fin includes a first slot and the second thermal fin includes a second slot, and further wherein the first thermal resistance material layer covers the first slot and the second thermal resistance material layer covers the second slot to form at least one sealed air pocket inside the thermal barrier assembly.

19. The battery pack as recited in claim 18, wherein the first slot and the second slot are aligned with one another.

20. The battery pack as recited in claim 18, wherein the first slot and the second slot are staggered relative to one another.
